(19) United States
(12) Patent Application Publication
(10) Pub. No.: US 2010/0135297 A1
(43) Pub. Date: Jun. 3, 2010

(54) UNICAST STREAMING OF MULTICAST CONTENT

(75) Inventors: Noam Brousard, Tel Aviv (IL); Rafi Ram, Herzliya (IL); Ronen Solomon, Ramat Gan (IL)

Correspondence Address: D. Kligler I.P. Services LTD, P.O. Box 25, Zippori, 17910, IL

(73) Assignee: CORRIGENT SYSTEMS LTD, Tel Aviv (IL)

(21) Appl. No.: 12/628,247

(22) Filed: Dec. 1, 2009

Related U.S. Application Data
(60) Provisional application No. 61/119,403, filed on Dec. 3, 2008.

(51) Int. Cl. H04L 12/56; H04L 29/02

(52) U.S. Cl. 370/390; 370/474

(57) ABSTRACT

A method for communication includes receiving an Internet Protocol Multicast (IPMC) packet for delivery to multiple subscribing hosts. The IPMC packet is encapsulated in a plurality of unicast frames that are respectively addressed to the subscribing hosts for transmission via a Layer 2 network to the subscribing hosts.

### CROSS-REFERENCE TO RELATED APPLICATION

This application claims the benefit of U.S. Provisional Patent Application 61/119,403, filed Dec. 3, 2008, which is incorporated herein by reference.

### FIELD OF THE INVENTION

The present invention relates generally to packet communication networks, and specifically to transmission of multicast packets over such networks.

### BACKGROUND OF THE INVENTION

Ethernet is a Layer 2 protocol, also known as a medium access control (MAC) or data link protocol. Most local area networks (LANs) are configured as Ethernet bridged networks, over which hosts transmit and receive Ethernet frames. Hosts that are located on the same LAN are interconnected through Layer 2 switches, such as hubs or bridges, for example.

The Internet Protocol (IP) is a Layer 3 protocol, also known as a network layer protocol. Hosts connected to IP networks transmit and receive IP packets (also known as IP datagrams). Hosts that are located on different subnets of an IP network are interconnected through routers. If an IP network uses Ethernet as its underlying data link network, the IP packets are encapsulated in Ethernet frames.

IP networks support unicast, multicast and broadcast transmission. IP multicast (IPMC) packets have Class D destination addresses, meaning that the four most significant bits of the 32-bit IP destination address are set to binary ‘1110’. The remaining 28 bits identify the IPMC group, which hosts may join in order to receive the multicast in question.

Aspects of IP multicasting are specified in detail by Deering in “Host Extensions for IP Multicasting,” which was published as Request for Comments (RFC) 1112 of the Internet Engineering Task Force (IETF) in August, 1989, and is incorporated herein by reference. In section 6.4, RFC 1112 describes standard methods for transmitting IPMC packets over Ethernet, using multicast addresses in the destination field of Ethernet packets. The RFC specifies a procedure for mapping IP host group addresses to Ethernet multicast addresses.

### SUMMARY OF THE INVENTION

Embodiments of the present invention that are described hereinbelow provide improved methods and systems for distribution of multicast traffic over Layer 2 networks.

There is therefore provided, in accordance with an embodiment of the present invention, a method for communication, including receiving an Internet Protocol Multicast (IPMC) packet for delivery to multiple subscribing hosts. The IPMC packet is encapsulated in a plurality of unicast frames that are respectively addressed to the subscribing hosts. The unicast frames are transmitted via a Layer 2 network to the subscribing hosts.

In some embodiments, encapsulating the IPMC packet includes inserting the IPMC packet in Ethernet unicast frames, each having a respective destination medium access control (MAC) address that is associated with a subscribing host. Typically, the IPMC packet includes a Class D destination IP address, and encapsulating the IPMC packet includes inserting the IPMC packet with the Class D destination IP address into a Layer 2 unicast frame having a unicast medium access control (MAC) address.

In a disclosed embodiment, receiving the IPMC packet includes receiving the IPMC packet at an edge router from a Wide Area Network (WAN), and transmitting the unicast frames includes sending the unicast frames to the subscribing hosts via a Layer 2 access network. The method may include receiving Internet Group Management Protocol (IGMP) membership messages at the edge router from the subscribing hosts, and learning medium access control (MAC) addresses of the subscribing hosts on the access network from the IGMP membership messages for transmission of the unicast frames thereto.

In some embodiments, transmitting the unicast frames includes personalizing one or more of the unicast frames responsively to characteristics respectively associated with the subscribing hosts. Personalizing the one or more of the unicast frames may include inserting personalized promotional content into a stream of the unicast frames. Alternatively or additionally, personalizing the one or more of the unicast frames may include adjusting a data rate of a stream of the unicast frames.

There is also provided, in accordance with an embodiment of the present invention, communication apparatus, including a first port coupled to receive an Internet Protocol Multicast (IPMC) packet from a Wide Area Network (WAN) for delivery to multiple subscribing hosts, and one or more second ports coupled to a Layer 2 network, to which the subscribing hosts are connected. A processor is configured to encapsulate the IPMC packet in a plurality of unicast frames that are respectively addressed to the subscribing hosts and to transmit the unicast frames over the Layer 2 network via the one or more second ports.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a Layer 2 access network over which multicast traffic is distributed in accordance with an embodiment of the present invention;

FIG. 2 is a flow chart that schematically illustrates a method for distribution of multicast packets, in accordance with an embodiment of the present invention; and

FIG. 3 is a block diagram that schematically shows details of an edge router, in accordance with an embodiment of the present invention.

### DETAILED DESCRIPTION OF EMBODIMENTS OVERVIEW

A Layer 2 switch forwards frames based only on their data link layer destination address (commonly known as the MAC address). The switch is typically not aware of Layer 3 or any other higher-layer protocols carried in the payload of the Layer 2 frame. If the frame has a unicast MAC destination address, the switch will forward it to a specific interface (port) behind which it previously learned that this address is located. If the frame has a multicast MAC destination address, the switch will replicate the frame, with the multicast MAC address, and will send a copy out through all of its interfaces (or possibly only the interfaces behind which there are hosts that have requested this multicast).

A Layer 3 router, on the other hand, forwards packets according to the network layer destination address. In order to receive IPMC traffic, IP hosts send Internet Group Management Protocol (IGMP) membership messages upstream to a multicast router specifying the multicast group that they want to join. The router will then replicate packets belonging to the requested multicast and will send them out through the interface(s) from which requests to join the multicast were previously received.

Upon receiving a downstream packet, a host typically processes the packet in the following manner: First it examines the Layer 2 frame header and accepts frames with either a unicast MAC destination address that matches the host's own unique MAC address, or a broadcast destination address, or a multicast destination address that corresponds (according to the above-mentioned RFC 1112) to the IPMC address of a multicast that the host has joined. After accepting a frame, the host removes the Layer 2 encapsulation and examines the network layer (IP) header. If the IP destination address is a multicast (IPMC) address, the host checks whether the address corresponds to one of the IPMC groups that the host has joined. If so, the host accepts the packet and continues with processing of the packet payload. Otherwise the packet is dropped.

In some network topologies, such as in access networks, an edge router receives Layer 3 multicast traffic from a Wide Area Network (WAN), such as the Internet, and forwards the multicast packets over a Layer 2 network to subscribing hosts that have requested them. For example, the hosts may request delivery of various video channels by video-over-IP multicasts. Typically, all subscribing hosts receive the same IPMC stream, as in conventional video broadcasts. In some cases, however, it may be desirable to send different, personalized versions of the IPMC stream to the subscribing hosts. Personalization of the IPMC stream may mean transmitting the stream at a specific rate or quality, depending on the link bandwidth or service level contracted for by each host, or with different embedded promotional content (commercials) from those received by other hosts that have subscribed to the same channel.

Therefore, in some embodiments of the present invention, a network element, such as an edge router, forwards IPMC traffic to the subscribing hosts in such a manner that each host (or at least some of the hosts) receives a personalized version of the requested IPMC stream. For this purpose, the network element converts the Layer 3 multicast stream into multiple unicast streams, each destined for a particular host. Specifically, the network element encapsulates each IPMC packet in multiple Layer 2 unicast frames that are respectively addressed to the subscribing hosts, and then transmits the unicast frames via a Layer 2 network to the hosts. Each such unicast frame may be personalized according to the host that is to receive it. This sort of personalization is not possible in the conventional multicast model dictated by RFC 1112, in which IPMC packets are distributed in Ethernet multicast frames, whereby each subscribing host receives exactly the same multicast stream.

A further advantage of the multicast-over-unicast model that is described herein is that it can be implemented entirely in a single network element, such as the edge router, without any modification to other existing network elements and hosts. The other network elements (such as switches) in the Layer 2 network between the edge router and the hosts forward the unicast MAC frames in the conventional manner, unaware that the unicast frames encapsulate multicast packets. Similarly, each subscribing host will recognize its own unique MAC address in the unicast frames that it receives and will therefore accept the frames for processing. At the next stage of processing, in which the host de-encapsulates the payload of the unicast frame, the host will recognize the multicast IP source address contained in the frame as identifying a multicast that it has requested. The host will then process the multicast data in the normal way, by playing the video content, for example, irrespective of the fact that the multicast packets were delivered by unicast.

### System Description

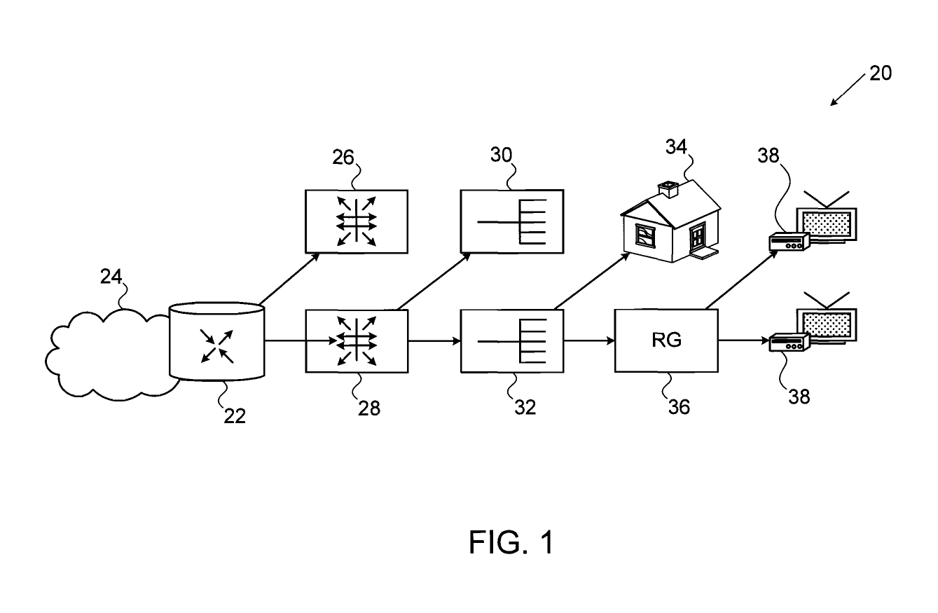

FIG. 1 is a block diagram that schematically illustrates a Layer 2 access network 20 over which multicast traffic is distributed in accordance with an embodiment of the present invention. An edge router 22 connects the access network to a WAN 24, such as the Internet. The edge router in this embodiment is configured as a broadband network gateway (BNG) for hosts on the access network, such as IPTV set-top boxes 38 and other end-users 34. This configuration, however, is shown here solely by way of example, and a separate gateway or other element in network 20 may perform the multicast processing functions that are attributed to the edge router hereinbelow. In the present embodiment, edge router 22 receives upstream IGMP messages from the hosts and transmits downstream IPMC packets from network 24 over network 20 accordingly. (The term “upstream,” in the context of the present patent application and in the claims, refers to the direction of transmission from hosts toward WAN 24, while “downstream” is the opposite direction.) For this purpose, the edge router encapsulates the IPMC packets in Ethernet unicast frames, as is described in greater detail hereinbelow.

In a typical configuration, access network 20 comprises one or more aggregation switches 26, 28, which connect to access switches 30, 32, such as digital subscriber line access multiplexers (DSLAMs), for example. Switches 26, 28, 30, 32 comprise Layer 2 elements, such as Ethernet bridges or hubs, which forward data frames according to the MAC destination address, using standard methods of address learning and forwarding. These Layer 2 switches are typically indifferent to the content of the frames that they forward.

Hosts may connect to access switches 30, 32 directly via Layer 2 connection, as in the case of end-user 34, or they may connect via a local switch, such as a remote gateway 36. Such remote gateways may be configured either as a Layer 2 (typically Ethernet) switch or a Layer 3 router. Gateway 36 forwards upstream IGMP messages from subscribing hosts, such as set-top boxes 38, over network 20 to edge router 22, and then receives the downstream unicast frames containing the IPMC packets that are destined to the hosts. If the gateway is configured as a Layer 2 switch, it simply forwards the frames according to the MAC destination address of the host. Otherwise, if the gateway is configured as a Layer 3 router, it forwards the IPMC packets according to the IP address. In either case, the gateway, like the other switches in network 20, uses conventional methods of address learning and forwarding and need not be aware that the downstream unicast frames that it receives from network 20 may encapsulate multicast packets.

### Methods for Personalizing and Forwarding Multicast Traffic

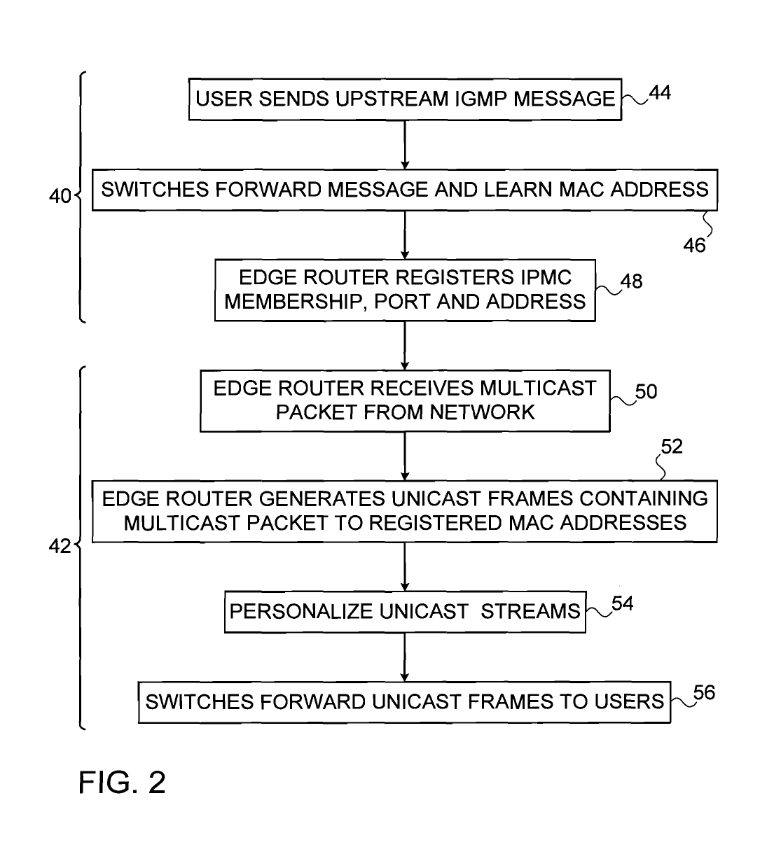

FIG. 2 is a flow chart that schematically illustrates a method for distribution of multicast packets, in accordance with an embodiment of the present invention. The method is described here, for the sake of clarity, with reference to the network elements and access network configuration that are shown in FIG. 1. In this configuration, IPMC traffic is encapsulated in data frames with Ethernet unicast destination MAC addresses. The IP destination address, identifying the IP multicast group, remains unchanged within the data frames, while the Ethernet destination address is the unique MAC address of the requesting host or of the remote gateway to which the host is connected. The method described below, however, is by no means limited to this specific network topology and protocols and may alternatively be applied in distribution of Layer 3 multicast traffic over other sorts of Layer 2 networks.

The method shown in FIG. 2 has two stages: a registration stage 40, in which a host subscribes with edge router 22 to receive a particular multicast; and a delivery stage 42, in which the requested multicast is delivered to the subscribing host. The two stages are shown in the figure as occurring sequentially, which indeed they do with respect to any given individual host. In practice, however, multiple hosts typically initiate stage 40 at different respective times, when the users choose to join a given multicast, while stage 42 takes place in parallel to serve multiple hosts and distribute multiple different multicasts simultaneously. Within stage 42, some or all of the multicasts are personalized for delivery to the respective hosts in unicast streams, and all hosts may thus receive personalized unicasts. Alternatively, the edge router may deliver the multicast traffic to at least some of the hosts without personalization, and may even continue to distribute multicast traffic to some hosts via conventional Ethernet multicast (in accordance with RFC 1112, for example) while using the unicast methods described below for other hosts and/or other multicasts.

To initiate stage 40, a user typically chooses a multicast program, by selecting a movie channel on his or her set-top box (STB) 38, for example. The STB sends an IGMP membership message upstream to edge router 22 in order to join the multicast group, at an IGMP transmission step 44. The message is carried through network 20 in a suitable Ethernet data frame. If STB 38 is served by remote gateway 36, the gateway may simply forward the IGMP packet unaltered, in which case the MAC source address of the upstream data frame is the MAC address of STB 38. Alternatively, the gateway may serve as an IGMP agent, in which case the gateway may insert its own MAC source address in the upstream data frame carrying the IGMP message. For example, remote gateway 36 may be configured as an IGMP proxy, in which case the IGMP message from STB 38 will be sent to router 22 only when it is the first join request for the multicast channel in question from any of the hosts served by the remote gateway.

Access switch 32 and aggregation switch 28 forward the upstream data frame containing the IGMP message from STB 38 to router 22, at an upstream forwarding step 46, without making any change in the packet. As part of the forwarding process, the switches learn behind which of their ports the MAC source address of the data frame is located, so that they can afterwards forward downstream frames destined to this address.

Edge router 22 receives the upstream data frame and registers the IGMP join request, at a registration step 48. The registration indicates that IPMC traffic in the multicast group requested in the IGMP message should be forwarded to the port of router 22 from which the IGMP message was received. The edge router records this information in a table, along with the MAC addresses of the hosts in the multicast group (which it learns from the upstream data frames carrying the IGMP messages). An example of this sort of table is shown below:

MULTICAST REPLICATION TABLE

| Multicast Group ID | Port | MAC Destinations |
|---|---|---|
| 224.0.0.5 | 1 | A, B, D |
| | 2 | C |
| 225.200.20.2 | 1 | A, B, G, H |

The same process is followed in stage 40 when other users ask to view the same channel (or other channels), and edge router 22 adds entries to the table accordingly. The only difference is in the MAC address that the switches in network 20 and router 22 learn in each case.

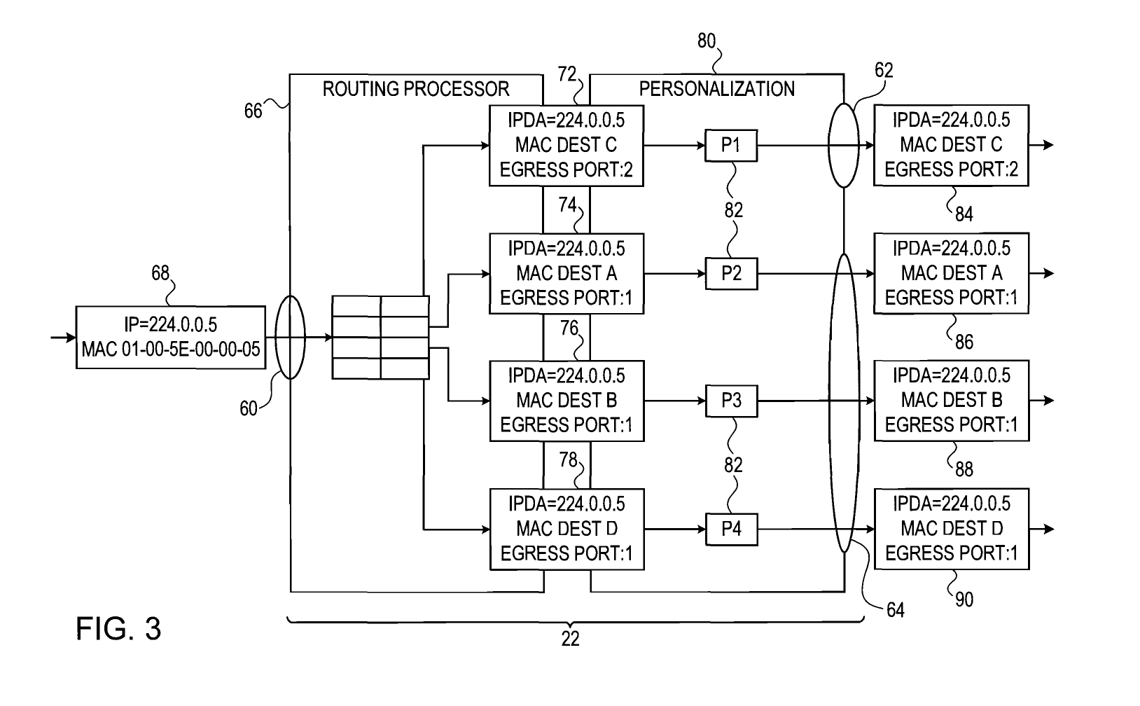

FIG. 3 is a block diagram that schematically shows details of edge router 22, in accordance with an embodiment of the present invention. This figure illustrates the flow of packets through the edge router in stage 42 (FIG. 2), as will be described in detail hereinbelow. In this simplified example, the edge router comprises an input port 60, connecting to WAN 24, and output ports 62 and 64, connecting to access network 20. (The ports may alternatively be referred to as “interfaces.”) A routing processor 66 in router 22 carries out the learning functions of stage 40 to build a multicast replication table 70, as described and shown above. Typically, the routing processor comprises a microprocessor, either general-purpose or specialized for network control functions, which has a suitable memory to hold table 70 and is programmed in software to carry out the functions that are described herein. Alternatively or additionally, the routing processor may comprise dedicated or programmable hardware logic circuits for these purposes, such as an application-specific integrated circuit (ASIC) or field-programmable gate array (FPGA), for example.

Stage 42 is initiated when edge router 22 receives an IPMC packet 68 from WAN 24, at a multicast reception step 50. The MAC destination address of the packet in this example is the MAC address associated with port 60. Processor 66 checks the IP destination address (multicast group ID) of the packet—224.0.0.5 in the present example—against the entries in multicast replication table 70.

Upon finding that the IP destination address of packet 68 matches an entry in table 70, processor 66 uses the information in the table in preparing Ethernet frames encapsulating the packet to be forwarded downstream, in a frame generation step 52. Based on the incoming sequence of IPMC packets from WAN 24, processor 66 generates a stream of unicast frames addressed to each host that is a member (subscriber) in the multicast group in question. Each stream has the unique MAC address of the destination host as its MAC destination address. The IP header in the payloads of these unicast frames, however, contains the IPMC destination address of the group. Thus, in the example shown in FIG. 3, processor 66 prepares a unicast downstream data frame 72 with MAC destination address “C” and IP destination address 224.0.0.5 for transmission through port 2 (based on the previously-learned port assignment for MAC “C” that is recorded in the table above). The processor also prepares three different unicast data frames 74, 76, 78 with this same IP destination address and respective MAC destination addresses A, B and D, for transmission through port 1.

A personalization processor 80 may personalize one or more of the streams of unicast data frames, at a personalization step 54. Such personalization may be applied to some or all of the unicast frames, by respective personalization modules 82, labeled P1 through P4 in the FIG. 3. Although the personalization processor is shown, for the sake of conceptual clarity, as a separate unit from routing processor 66, the functions of these two processors may be implemented in practice by the same microprocessor or other processing unit. Alternatively, the personalization processor may comprise a separate and independent microprocessor in edge router 22. As a further alternative, the personalization of the unicast data streams may be carried out externally to the edge router, by another unit farther downstream in network 20. In any case, the unicast nature of the transmissions facilitates personalization in a way that cannot be achieved if conventional Ethernet multicasting is used.

Various types of personalization are possible at step 54. Processor 80 may draw on a user database to find characteristics of the users of the hosts listed in table 70 (or these characteristics may themselves be listed in table 70), and may modify the respective unicast streams based on these characteristics. For example, the characteristics may include demographics or other information about user tastes and preferences, and processor 80 may apply this information in choosing targeted promotional content (such as advertisements) to insert at appropriate points in the multicast program. Thus all of the subscribing users will receive the same multicast simultaneously, but they may see different advertisements during the commercial breaks.

As another example, processor 80 may access information regarding the quality of the respective network link serving each of the subscribing hosts. This quality information may indicate the nominal bandwidth or the currently-available bandwidth on each network link or, alternatively or additionally, differentiated service levels for which different users have contracted with the operator of access network 20. Processor 80 may then use this information in adjusting the respective data rate of the stream of unicast frames that is transmitted to each host. For instance, in an IP video multicast, processor 80 may modify the data payloads of the frames in order to adjust the resolution of the video images in different unicast streams, using methods of processing that are known in the art. This modification can be controlled to match the nominal bandwidth allocation for each host and/or to compensate for changes in available bandwidth during the multicast program.

After any personalization has been carried out, edge router 22 transmits downstream Ethernet frames 84, 86, 88, 90 through the appropriate ports 62, 64. (Port 62 in FIG. 3 corresponds to egress port 2 and connects to aggregation switch 26, while port 64 corresponds to egress port 1 and connects to aggregation switch 28, as shown in FIG. 1.) Externally, frames 84, 86, 88, 90 are standard Ethernet unicast frames, and they are therefore forwarded downstream by switches 26, 28, 30 and 32 according to Ethernet convention, at a downstream forwarding step 56. For example, aggregation switch 28 may have learned from previous upstream frames that downstream frames to MAC destination address A are to be forwarded via a certain port to access switch 30, while frames to MAC destination addresses B and D are to be forwarded via another port to access switch 32. By the same token, access switch 32 may forward frames for MAC address B to host 34 and for MAC address D to remote gateway 36. The receiving host then de-encapsulates the IPMC packet from the downstream frame and plays the multicast.

When the downstream data frames containing IPMC packets arrive at remote gateway 36, two scenarios are possible:
If the remote gateway is configured as an IGMP router or proxy, then the MAC destination address (“D”) of packet 90 will be the MAC address of the remote gateway itself. In this case, the remote gateway, as MAC addressee, will accept the data frame, remove the Ethernet encapsulation, and process the IPMC packet inside. For this latter purpose, the remote gateway will consult its own IGMP table and will then forward the packet to the STBs 38 that are registered in the table as having joined this multicast. (In this case, multiple STBs or other hosts may share the same personalization, since they are served by a single unicast stream to the remote gateway.)
If there is no active IGMP agent in remote gateway 36, the remote gateway will simply forward the downstream frames to each of STBs 38 on the basis of the respective MAC destination address, since in this case address “D” will be the MAC address of the STB itself. (This will also be the case if the remote gateway is configured as an IGMP snooping agent, although in this case the remote gateway will forward the packet to the STB based on the IPMC destination address regardless of the Ethernet MAC address.) The STB will accept the packet, since at the Ethernet layer the packet is destined solely to the MAC address of the STB. It will then remove the Ethernet encapsulation, process the IP multicast information, and play the multicast content.

Thus, notwithstanding the multicast-to-unicast encapsulation and personalization carried out by edge router 22, all the other elements of network 20, including STBs 38 and other hosts, operate conventionally. In this way, multicast personalization is supported by the network without hardware or software changes except at the edge router.

Although the embodiments described above relate, for the sake of clarity, specifically to IP and Ethernet protocols and to a certain access network topology, the principles of the present invention may similarly be applied in other networks, as well as using other Layer 2 and Layer 3 protocols. For example, the techniques described above may be used, mutatis mutandis, in transmitting IP multicasts over Layer 2 Resilient Packet Rings (RPR, as specified by IEEE Standard 802.17) or Wireless Local Area Networks (WLAN, IEEE 802.11).

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
receiving an Internet Protocol Multicast (IPMC) packet for delivery to multiple subscribing hosts;
encapsulating the IPMC packet in a plurality of unicast frames that are respectively addressed to the subscribing hosts; and
transmitting the unicast frames via a Layer 2 network to the subscribing hosts.

2. The method according to claim 1, wherein encapsulating the IPMC packet comprises inserting the IPMC packet in Ethernet unicast frames, each having a respective destination medium access control (MAC) address that is associated with a subscribing host.

3. The method according to claim 1, wherein the IPMC packet includes a Class D destination IP address, and wherein encapsulating the IPMC packet comprises inserting the IPMC packet with the Class D destination IP address into a Layer 2 unicast frame having a unicast medium access control (MAC) address.

4. The method according to claim 1, wherein receiving the IPMC packet comprises receiving the IPMC packet at an edge router from a Wide Area Network (WAN), and wherein transmitting the unicast frames comprises sending the unicast frames to the subscribing hosts via a Layer 2 access network.

5. The method according to claim 4, and comprising receiving Internet Group Management Protocol (IGMP) membership messages at the edge router from the subscribing hosts, and learning medium access control (MAC) addresses of the subscribing hosts on the access network from the IGMP membership messages for transmission of the unicast frames thereto.

6. The method according to claim 1, wherein transmitting the unicast frames comprises personalizing one or more of the unicast frames responsively to characteristics respectively associated with the subscribing hosts.

7. The method according to claim 6, wherein personalizing the one or more of the unicast frames comprises inserting personalized promotional content into a stream of the unicast frames.

8. The method according to claim 6, wherein personalizing the one or more of the unicast frames comprises adjusting a data rate of a stream of the unicast frames.

9. Communication apparatus, comprising:
a first port coupled to receive an Internet Protocol Multicast (IPMC) packet from a Wide Area Network (WAN) for delivery to multiple subscribing hosts;
one or more second ports coupled to a Layer 2 network, to which the subscribing hosts are connected; and
a processor, which is configured to encapsulate the IPMC packet in a plurality of unicast frames that are respectively addressed to the subscribing hosts and to transmit the unicast frames over the Layer 2 network via the one or more second ports.

10. The apparatus according to claim 9, wherein the unicast frames are Ethernet unicast frames, each having a respective destination medium access control (MAC) address that is associated with a subscribing host.

11. The apparatus according to claim 9, wherein the IPMC packet includes a Class D destination IP address, and wherein the processor is configured to insert the IPMC packet with the Class D destination IP address into a Layer 2 unicast frame having a unicast medium access control (MAC) address.

12. The apparatus according to claim 9, wherein processor is configured to serve as an edge router, wherein the first port is connected to a Wide Area Network (WAN), and wherein the Layer 2 network comprises an access network.

13. The apparatus according to claim 12, wherein the processor is configured to receive Internet Group Management Protocol (IGMP) membership messages from the subscribing hosts, and to learn medium access control (MAC) addresses of the subscribing hosts on the access network from the IGMP membership messages for transmission of the unicast frames thereto.

14. The apparatus according to claim 9, wherein the processor is configured to personalize one or more of the unicast frames responsively to characteristics respectively associated with the subscribing hosts.

15. The apparatus according to claim 14, wherein the processor is configured to insert personalized promotional content into a stream of the unicast frames.

16. The apparatus according to claim 14, wherein the processor is configured to adjust a data rate of a stream of the unicast frames.
